(19) United States
(12) Patent Application Publication
(10) Pub. No.: US 2019/0354865 A1
(43) Pub. Date: Nov. 21, 2019

(54) VARIANCE PROPAGATION FOR QUANTIZATION

(71) Applicant: QUALCOMM Incorporated, San Diego, CA (US)

(72) Inventors: Matthias REISSER, Weesp (NL); Max WELLING, Bussum (NL); Efstratios GAVVES, Amsterdam (NL); Christos LOUIZOS, Utrecht (NL)

(21) Appl. No.: 16/417,430

(22) Filed: May 20, 2019

(30) Foreign Application Priority Data
May 18, 2018 (GR) 20180100221

(51) Int. Cl. G06N 3/08; G06K 9/62

(52) U.S. Cl. CPC G06N 3/082; G06K 9/6277; G06K 9/627; G06N 3/086

(57) ABSTRACT

A neural network may be configured to receive, during a training phase of the neural network, a first input at an input layer of the neural network. The neural network may determine, during the training phase, a first classification at an output layer of the neural network based on the first input. The neural network may adjust, during the training phase and based on a comparison between the determined first classification and an expected classification of the first input, weights for artificial neurons of the neural network based on a loss function. The neural network may output, during an operational phase of the neural network, a second classification determined based on a second input, the second classification being determined by processing the second input through the artificial neurons using the adjusted weights.

### CROSS-REFERENCE TO RELATED APPLICATION(S)

This application claims priority to Greek Patent Application 20180100221, entitled “VARIANCE PROPAGATION FOR QUANTIZATION” and filed on May 18, 2018, which is expressly incorporated by reference herein in its entirety.

### BACKGROUND

### Field

Certain aspects of the present disclosure generally relate to machine learning and, more particularly, to a machine-learning model or neural network that implements quantization.

### Description of Related Technology

An artificial neural network, which may include an interconnected group of artificial neurons (e.g., neuron models), is a computational device or represents a method to be performed by a computational device.

Convolutional neural networks are a type of feed-forward artificial neural network. Convolutional neural networks may include collections of neurons that each has a receptive field and that collectively tile an input space. Convolutional neural networks (CNNs) have numerous applications. In particular, CNNs have broadly been used in the area of pattern recognition and classification.

Deep learning architectures, such as deep belief networks and deep convolutional networks, are layered neural networks architectures in which the output of a first layer of neurons becomes an input to a second layer of neurons, the output of a second layer of neurons becomes and input to a third layer of neurons, and so on. Deep neural networks (DNNs) may be trained to recognize a hierarchy of features and so they have increasingly been used in object recognition applications. Like convolutional neural networks, computation in these deep learning architectures may be distributed over a population of processing nodes, which may be configured in one or more computational chains. These multi-layered architectures may be trained one layer at a time and may be fine-tuned using back propagation.

Other models are also available for object recognition. For example, support vector machines (SVMs) are learning tools that can be applied for classification. Support vector machines include a separating hyperplane (e.g., decision boundary) that categorizes data. The hyperplane is defined by supervised learning. A desired hyperplane increases the margin of the training data. In other words, the hyperplane should have the greatest minimum distance to the training examples.

Although these solutions achieve excellent results on a number of classification benchmarks, their computational complexity can be prohibitively high. Additionally, training of the models may be challenging.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

In various aspects of the disclosure, a method, a computer-readable medium, and an apparatus for operating a neural network are described herein. For example, an apparatus for operating a neural network may be configured to receive, during a training phase of the neural network, a first input at an input layer of the neural network. The apparatus for operating the neural network may be further configured to determine, during the training phase, a first classification at an output layer of the neural network based on the first input; adjust, during the training phase and based on a comparison between the determined first classification and an expected classification of the first input, weights for artificial neurons of the neural network based on a loss function—the loss function being based on a cross-entropy function, and the cross-entropy function being a function of a mean μ and a variance σ² associated with the expected classification.

In one aspect, the loss function may include a sum of a negative log likelihood function and the cross-entropy function, and the negative log likelihood function may be a function of the first input and the expected classification. The apparatus for operating the neural network may be further configured to output a second classification determined based on a second input, the second classification being determined by processing the second input through the artificial neurons using the adjusted weights.

In one aspect, a scalar α is applied to the cross-entropy function, and the scalar α is greater than 0. In another aspect, the cross-entropy function is a function of a softmax operation that is based on the mean μ and the variance σ². In a further aspect, the cross-entropy function is a function of a vector h, a respective element hᵢ being equal to μᵢ−δσ²ᵢ when the expected classification for an i^{th} output layer neuron is equal to 1, and the respective element hᵢ being equal to μᵢ+δσ²ᵢ when the expected classification for the i^{th} output layer neuron is equal to 0, and μᵢis the mean of the expectation for the i^{th} output layer neuron, σ²ᵢ is the variance of the expectation for the i^{th} output layer neuron, and δ is a scalar greater than 0.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIGS. 3A and 3B are diagrams illustrating neural networks in accordance with aspects of the present disclosure.

FIG. 3C is a block diagram illustrating an exemplary deep convolutional network (DCN) in accordance with aspects of the present disclosure.

FIG. 4 is a block diagram illustrating an exemplary software architecture that may modularize artificial intelligence (AI) functions in accordance with aspects of the present disclosure.

FIG. 5 is a block diagram illustrating the run-time operation of an AI application on a smartphone in accordance with aspects of the present disclosure.

FIG. 6 is a block diagram illustrating quantization for a machine-learning model or neural network in accordance with certain aspects of the present disclosure.

FIG. 7 is a block diagram illustrating a neural network in accordance with certain aspects of the present disclosure.

FIG. 8 is a block diagram illustrating an output layer of a neural network in accordance with certain aspects of the present disclosure.

FIG. 9 is a flow chart illustrating a method of variance propagation for quantization for a machine-learning model or neural network in accordance with certain aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

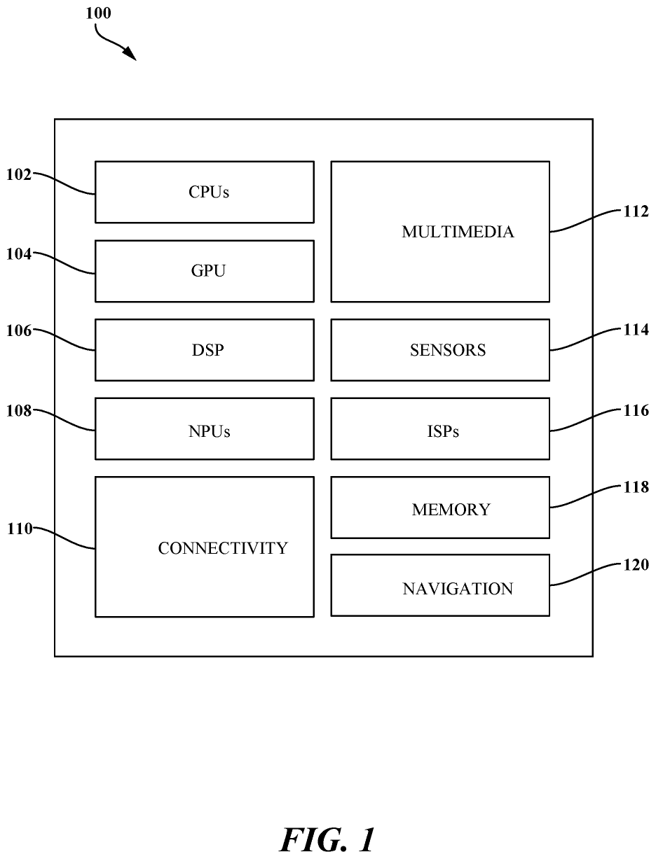

FIG. 1 illustrates an example implementation of a neural network using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a Neural Processing Unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, 5G New Radio (NR) connectivity, Wi-Fi and/or other wireless local area network connectivity, USB connectivity, Bluetooth and/or Bluetooth Low Energy connectivity, and the like, and a multimedia processor 112 that may, for example, detect and recognize gestures. In one implementation, the NPU is implemented in the CPU(s) 102, DSP 106, and/or GPU 104. The SOC 100 may also include a sensor processor 114, image signal processors (ISPs) 116, and/or navigation 120, which may include a global positioning system.

The SOC 100 may be based on an ARM instruction set. In an aspect of the present disclosure, the instructions loaded into the general-purpose processor 102 may include code for a neural network, including code to receive, during a training phase of the neural network, a first input at an input layer of the neural network. The instructions loaded into the general-purpose processor 102 may further include code to determine, during the training phase, a first classification at an output layer of the neural network based on the first input; adjust, during the training phase and based on a comparison between the determined first classification and an expected classification of the first input, weights for artificial neurons of the neural network based on a loss function. The loss function may be based on a cross-entropy function, and the cross-entropy function may be a function of a mean μ and a variance σ² associated with the expected classification. The instructions loaded into the general-purpose processor 102 may further include code to output a second classification determined based on a second input, the second classification being determined by processing the second input through the artificial neurons using the adjusted weights.

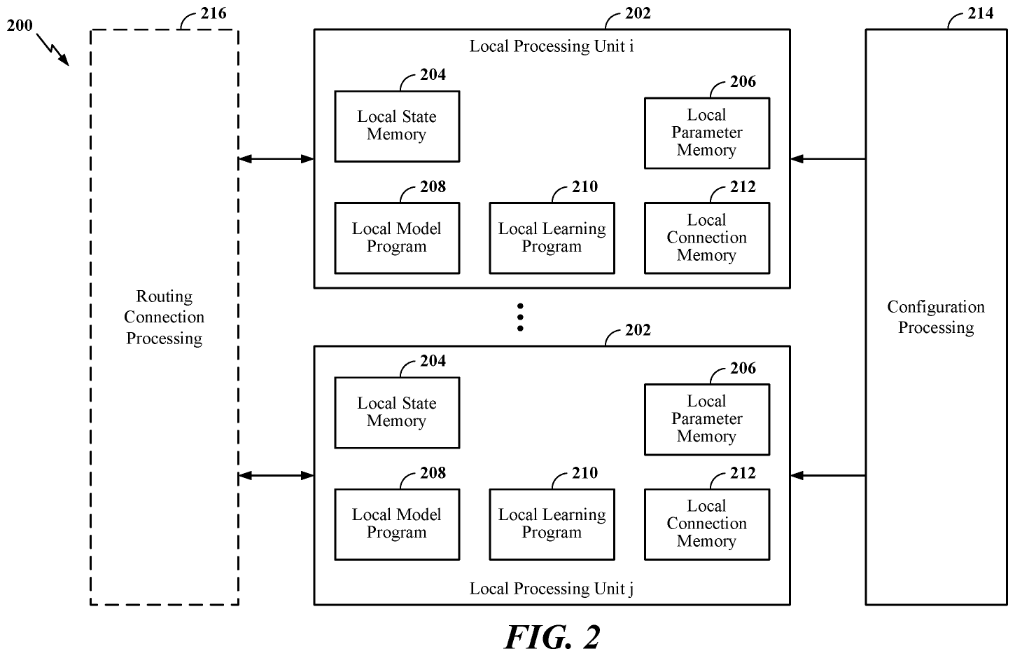

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may include a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

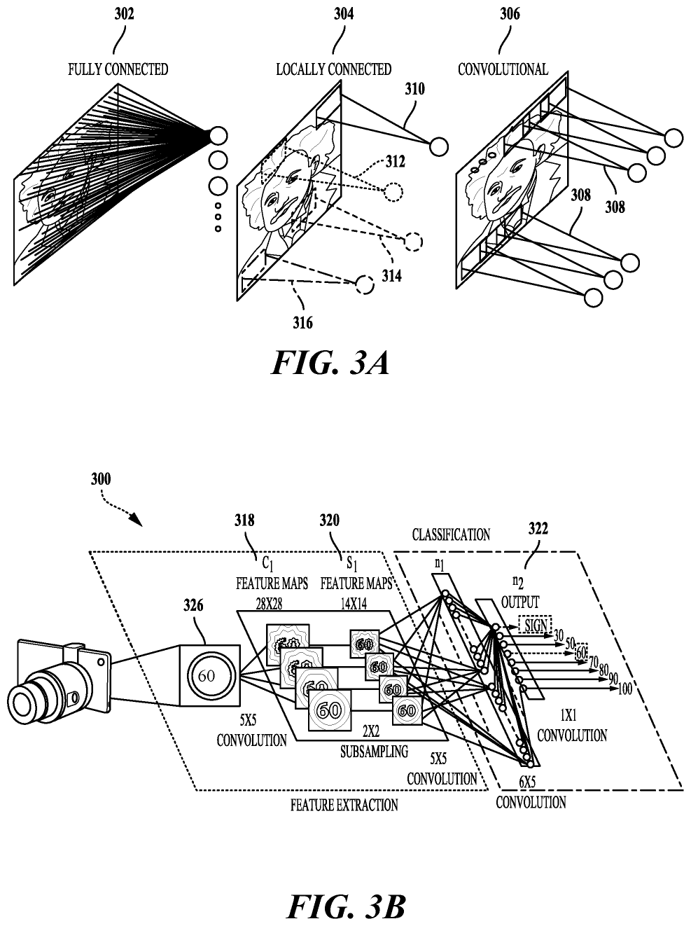

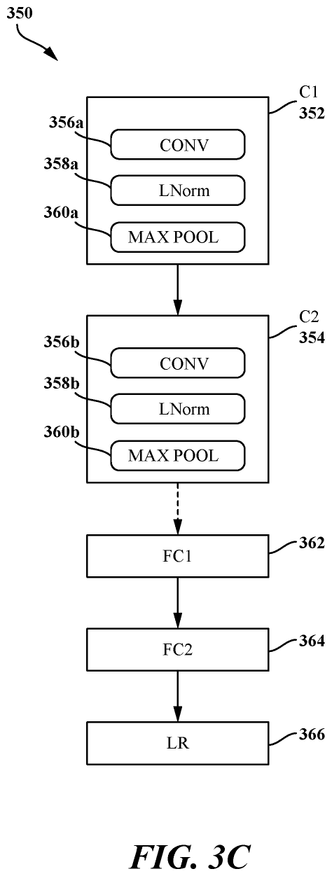

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

With reference to FIG. 3B, locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A deep convolutional network (DCN) may be a network of convolutional network(s), configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that includes recurrent or feedback connections.

A DCN may be trained with supervised learning. During training, a DCN may be presented with an image, such as a cropped image 326, such as a speed limit sign. The DCN may then compute a “forward pass” to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with an image 326, which may be a new image: A forward pass through the network may yield an output 322 that may be considered an inference or a prediction of the DCN.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max (0,x), which may be performed by a rectified linear unit (ReLU). Values from adjacent neurons may be further pooled, which corresponds to down sampling, and may provide additional local invariance and dimensionality reduction. Normalization, which corresponds to whitening, may also be applied through lateral inhibition between neurons in the feature map.

The performance of deep learning architectures may increase as more labeled data points become available or as computational power increases. Modern deep neural networks (DNNs) are routinely trained with computing resources that are thousands of times greater than what was available to a typical researcher just fifteen years ago. New architectures and training paradigms may further boost the performance of deep learning. Rectified linear units may reduce a training issue known as vanishing gradients. New training techniques may reduce over-fitting and thus enable larger models to achieve better generalization. Encapsulation techniques may abstract data in a given receptive field and further boost overall performance.

FIG. 3C is a block diagram illustrating an exemplary deep convolutional network 350. The deep convolutional network 350 may include multiple different types of layers based on connectivity and weight sharing. As shown in FIG. 3C, the exemplary deep convolutional network 350 includes multiple convolution blocks, including C1 352 and C2 354. Each of the convolution blocks 352, 354 may be configured with a convolution layer (CONV) 356a, 356b, an optional normalization layer (LNorm) 358a, 358b, and an optional pooling layer (MAX POOL) 360a, 360b. The convolution layers 356a, 356b may include one or more convolutional filters, which may be applied to the input data to generate a feature map. Convolution layers 356a, 356b may also include corresponding non-linearity modules such as a ReLUs. Although only two convolution blocks 352, 354 are shown, the present disclosure is not so limiting, and instead, any number of convolutional blocks may be included in the deep convolutional network 350 according to design preference. The normalization layer 358a, 358b may be used to normalize the output of the convolution filters. For example, the normalization layer 358a, 358b may provide whitening or lateral inhibition. The pooling layer 360a, 360b may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers, such as FC1 362 and FC2 364. The deep convolutional network 350 may further include a multinomial logistic regression (LR) layer 366, which applies a softmax function. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1 352.

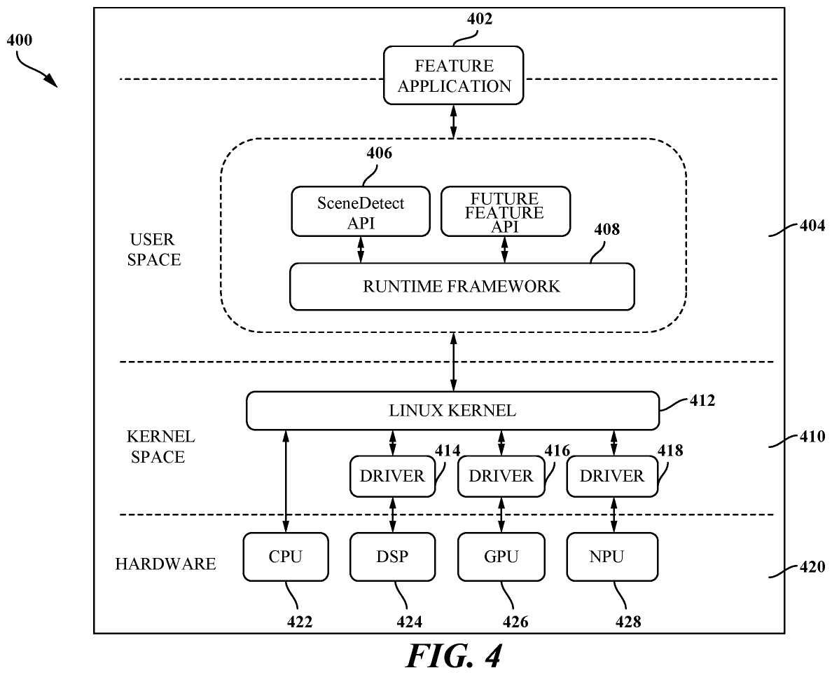

FIG. 4 is a block diagram illustrating an exemplary software architecture 400 that may modularize artificial intelligence (AI) functions. Using the architecture, applications 402 may be designed that may cause various processing blocks of an SOC 420 (for example a CPU 422, a DSP 424, a GPU 426 and/or an NPU 428) to perform supporting computations during run-time operation of the application 402.

The AI application 402 may be configured to call functions defined in a user space 404 that may, for example, provide for the detection and recognition of a scene indicative of the location in which the device currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an application programming interface (API) 406 to provide an estimate of the current scene. This request may ultimately rely on the output of a deep neural network configured to provide scene estimates based on video and positioning data, for example.

A run-time engine 408, which may be compiled code of a runtime framework, may be further accessible to the AI application 402. The AI application 402 may cause the run-time engine, for example, to request a scene estimate at a particular time interval or triggered by an event detected by the user interface of the application. When caused to estimate the scene, the run-time engine may in turn send a signal to an operating system 410, such as a Linux kernel 412, running on the SOC 420. The operating system 410, in turn, may cause a computation to be performed on the CPU 422, the DSP 424, the GPU 426, the NPU 428, or some combination thereof. The CPU 422 may be accessed directly by the operating system, and other processing blocks may be accessed through a driver, such as a driver 414-418 for a DSP 424, for a GPU 426, or for an NPU 428. In the exemplary example, the deep neural network may be configured to run on a combination of processing blocks, such as a CPU 422 and a GPU 426, or may be run on an NPU 428, if present.

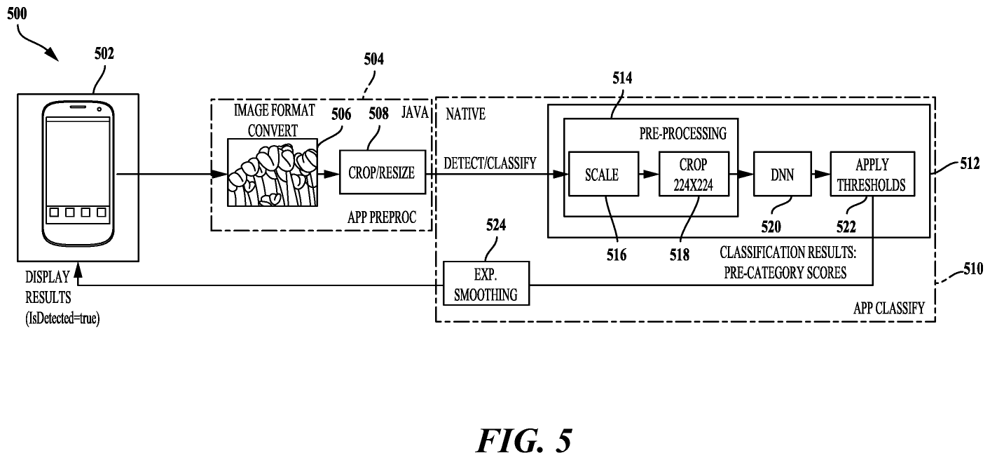

FIG. 5 is a block diagram illustrating the run-time operation 500 of an AI application on a smartphone 502. The AI application may include a pre-process unit 504 that may be configured to convert the format of an image 506 and then crop and/or resize the image 508. The pre-processed image may then be communicated to a classify application 510 that contains a backend engine 512 that may be configured to detect and classify scenes based on visual input. The backend engine 512 may be configured to further preprocess 514 the image by scaling 516 and cropping 518. For example, the image may be scaled and cropped so that the resulting image is 224 pixels by 224 pixels. These dimensions may map to the input dimensions of a neural network. The neural network may be configured by a deep neural network block 520 to cause various processing blocks of the SOC 100 to further process the image pixels with a deep neural network. The results of the deep neural network may then be thresholded 522 and passed through an exponential smoothing block 524 in the classify application 510. The smoothed results may then cause a change of the settings and/or the display of the smartphone 502.

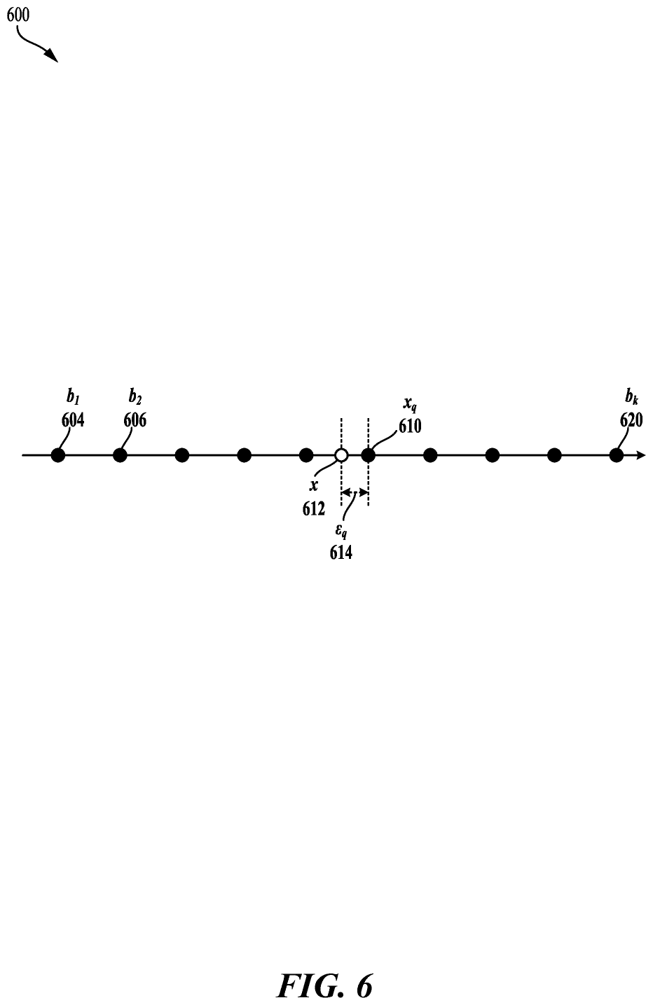

In certain aspects, the SOC 100, the system 200, the network 300, the DCN 350, the architecture 400, and/or the smartphone 502 may be configured to propagate variance for quantization robustness and/or to operate a neural network trained on variance propagation (e.g., as in the case of a smartphone 502), as is described herein at FIGS. 6-9. With reference to FIGS. 6-9, variance propagation for quantization robustness may be described in relation to a machine-learning model or neural network (e.g., DNN), hereinafter “neural network.”

According to various aspects, a neural network (e.g., a DNN) may provide relatively accurate predictions in various domains, including images, speech, text, natural language, and so forth. For example, a neural network may be implemented for object recognition in images, speech recognition, sentiment analyses, machine translation, and the like. Such a neural network may implement a plurality of layers of artificial neurons or units, with the plurality of layers providing successive computations on input data (e.g., matrix multiplications or convolutions) combined with nonlinear transformations that transform the input data into a high-level representation. Empirical observation indicates that such computations are commensurate with high-precision computations, without which the predictive performance of the neural network may suffer. Accordingly, neural networks may be trained on GPU and/or CPUs that implement single-precision or double-precision operations.

Evaluating a neural network on a new data point (e.g., in a production environment) may be reliant on high-precision operations in order to avoid performance losses. Thus, operations commensurate with high-precision computations (e.g., in at least one of training and/or evaluation in production) may be performed in data center(s) that house hardware suitable for such high-precision computations. For example, a personal computing device (e.g., smart phone) may generate or acquire a data set and send that data set to a data center. The data center may perform the high-precision computation(s) and provide the result(s) to the personal computing device. By way of illustration, a personal computing device may capture spoken words and perform some relatively minimal preprocessing of the spoken words before sending the preprocessed spoken words to a data center at which actual speech recognition is performed. The data center may send the result (e.g., final text representing the capture spoken words) to the personal computing device.

In some scenarios, sending a data set to a data center may be undesirable and/or infeasible. However, devices that generate or acquire input data may also lack the resources (e.g., hardware, power, etc.) generally needed for high-precision computations (e.g., otherwise available at data centers). Examples of such devices may include smart phones, personal data assistants, smart watches, tablet computers, augmented reality (AR) wearables (e.g., AR glasses), Internet-of-Things (IoT) devices (e.g., home appliances), and other similar devices.

In view of the foregoing, a need exists for locally performing low-precision computations that are relatively as effective as high-precision computations (e.g., on-device successive computations of input data) on devices that may be more suitable for low-precision computations and/or low-power operation. As is described herein, a neural network may be trained in order to minimize performance loss due to evaluation on low-precision and/or low-power hardware. To that end, FIGS. 6-9 describe an approach to regularization for a neural network that is based on variance propagation through the neural network. In applying such an approach to regularization, the undesirable performance effects introduced by low-precision and/or low-power devices may be reduced when locally implementing a neural network. For example, regularization based on variance propagation may regularize the neural network toward a solution that is amenable to quantization. In particular, the variance induced by quantization may be propagated through the neural network, and the neural network may regularize against the negative effects of such variance.

As used herein, quantization may describe a process in which a high-precision number is transformed into a relatively lower-precision number. In order to perform quantization, a rounding operation of some form may be performed. FIG. 6 illustrates a diagram 600 of quantization of input. An example of a rounding operation may be given herein with respect to Equation 1 and Equation 2.

x_{q}, ε_{q}=q(x; b) (Equation 1)

ε_{q}=x_{q}−x (Equation 2)

In the foregoing Equation 1 and Equation 2, x 612 may be an input that is to be quantized, q may be a rounding function that performs the quantization, x_{q} 610 may be the quantized input, ε_{q} 614 may be the quantization error that is introduced. A set of discrete values b=[b₁, . . . , bₖ] may be based on which inputs are to be rounded, for example, including b₁ 604, b₂ 606, and so forth through bₖ 620.

In theory, a neural network may observe inputs that are included in the set of real numbers [symbol] . In practice, however, the neural network may fail to truly represent real numbers because the number of points on a line representing [symbol] may be uncountable. Moreover, the neural network may encounter a number in [symbol] that involves an infinite level of precision, which corresponds to an infinite memory—for example, some rational numbers (e.g., 1/3) or irrational numbers (e.g., \sqrt{2}). In order to address such inputs, various real numbers of [symbol] may be represented using commonly agreed-upon numerical formats, such as “double floating point precision” (e.g., float 64 using 64 bits) or “single floating point precision (float32 using 32 bits). Mapping a number of [symbol] onto another number with respect to a specific numerical format may accomplished through quantization.

In some aspects, a CPU 102 and/or GPU 104 may provide chip(s) and/or instructions for performing quantization with respect to specific numerical types. Further, the chip(s) and/or instructions of the CPU 102 and/or GPU 104 may be configured to perform various arithmetic operations given numbers represented using those specific numerical types (e.g., addition, subtraction, multiplication, division, etc.). As the CPU 102 and/or GPU 104 may tend toward efficiency, the chip(s) and/or instructions may implement numerical types of relatively lower accuracy, such as 8-bit fixed-point arithmetic (int8). For example, a CPU 102 and/or GPU 104 may include mobile processors that provide instructions for quantization and operation in a numerical type of relatively lower accuracy (e.g., int8).

However, one or more algorithms of a neural network may assume access to numerical formats of real numbers, such as float 64 or float32. Consequently, the CPU 102 and/or GPU 104 instructions (e.g., in int8) may be incongruous with respect to the algorithms of the neural network (e.g., in float64 or float32). To address this incongruity, the weights of a trained neural network may be adjusted or transformed from one numerical type (e.g., float64 or float32) to another numerical type (e.g., int8). Therefore, instead of the infinite real numbers in [symbol] , only 2⁸=256 distinct numbers may be used. However, the algorithms of the neural network may be untrained to account for this lossy conversion and, therefore, the precision of the algorithms of the neural network may be reduced. Such reduction in precision may cause the neural network to inaccurately predict an output given an input.

According to the present disclosure, variance propagation may be introduced in connection with quantization. The quantization operation of rounding may be interpreted as adding noise to a high-precision value. Referring back to Equation 2, written differently, x_{q}=x+ε_{q}. That is, the quantized input x_{q} 612 may be the sum of the input x 610 and the quantization error that is introduced ε_{q} 614. Therefore, quantization may be viewed as the addition of a noise variable ε_{q} 614 on an actual measurement that is the input x 610. In effect, x_{q} 612 may follow a particular distribution that is controlled by the distribution of ε_{q} 614.

In the context of a neural network, therefore, the weights of the neural network may be quantized by inducing such a distribution on the weights. In order to work with an estimate of that induced noise, the distribution may be modeled as a uniform distribution, such that the support of the uniform distribution contains the nearest representable number (e.g., in the selected numerical type, such as int8) found in b₁ 604, b₂ 606, and through bₖ 620. According to another aspect, the distribution may be modeled using logistic noise instead of uniform noise. For example, the noise may be distributed according to a zero mean logistic distribution with a standard deviation. The cumulative distribution function of the logistic distribution may be a sigmoid function, which may be evaluated and backpropagated through, e.g., in order to identify the nearest representable number.

In various aspects, the primary operations of a neural network may take the form of linear transformations, as shown in Equation 3.

z=Wx (Equation 3)

In Equation 3, W includes a weight, in which a bias is subsumed. Assuming a distribution over W, as well as a distribution over an input x, such that x and W are independent, then the Lyapunov central limit theorem indicates that the variable z follows a Gaussian distribution with analytically computable mean μ and variance σ². Furthermore, in a neural network, linear transformations may be followed by nonlinear activations, as shown in Equation 4. In some aspects, a nonlinear activation in a neural network may be a ReLU function, as shown in Equation 5.

a=h(z) (Equation 4)

a=max(0,z) (Equation 5)

Assuming a Gaussian distribution over z, the post-ReLU activation a will follow a distribution that is a mixture between a delta spike at zero and a truncated Gaussian distribution. The first moment and second moment of the post-ReLU variable may be analytically computed, which allows the propagation of the variance to be modeled through the cascaded (e.g., hidden) layers of a neural network. This variance propagation through the neural network may be differentiable with respect to the weights of the neural network.

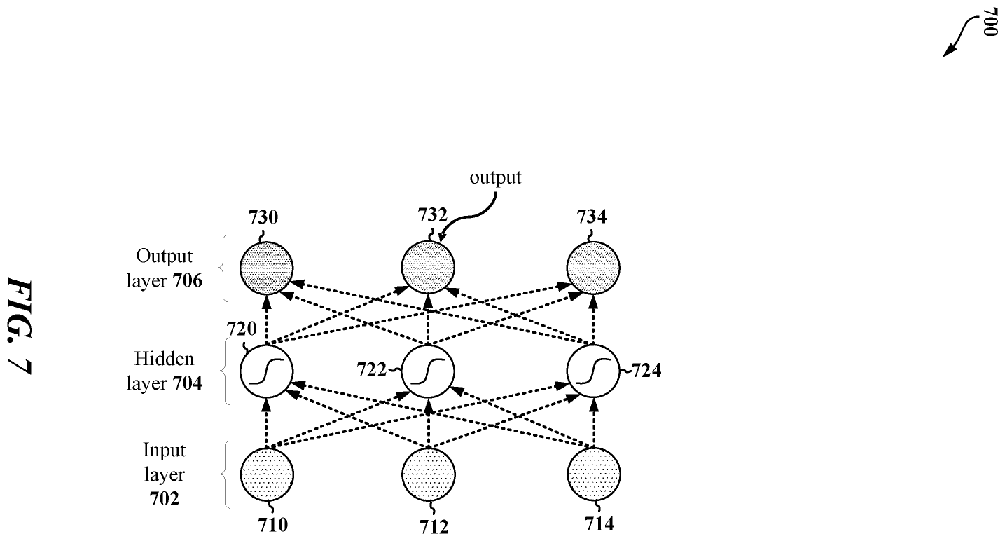

With reference to FIG. 7, variance propagation may be observed through the layers 702, 704, 706 of the neural network 700. By way of illustration, the neural network 700 may be fully connected, although other possible layer operations are contemplated by the present disclosure (e.g., convolutional layers, matrix multiplication, etc.). The network 700 may include an input layer 702, at least one hidden layer 704, and an output layer 706.

The input layer 702 may include a first set of neurons 710, 712, 714 at which an input may be received. The input layer 702 may be connected with at least one hidden layer 704. The at least one hidden layer 704 may include a second set of neurons 720, 722, 724. While FIG. 7 illustrates one hidden layer having three neurons, any number of hidden layers having any number of neurons may be possible. In some aspects, the at least one hidden layer 704 may include a ReLU layer.

At the output layer 706, the network 700 may include a third set of neurons 730, 732, 734. In various aspects, each neuron of the third set of neurons 730, 732, 734 may correspond to a respective label or classification, and an input X may be predicted by the network 700 to correspond to one classification based on the activation of one of the neurons 730, 732, 734.

Each connection between the neurons 710, 712, 714, 720, 722, 724, 730, 732, 734 of the layers 702, 704, 706 may be assigned a respective weight, which may influence the activation of each of the neurons 710, 712, 714, 720, 722, 724, 730, 732, 734. For example, different weights may be applied to each of the neurons 720, 722, 724 of the hidden layer 704 for respective calculations—for example, each of the neurons 720, 722, 724 may comprise a function (e.g., an activation function) in which a respective weight may be a variable. The outputs of one or more of the neurons 720, 722, 724 of the hidden layer 704 may be provided as inputs into each of the neurons 730, 732, 734 of the output layer 706. In other words, the inputs from the neurons 720, 722, 724 may differently influence the activation functions of the neurons 730, 732, 734. During training, the weight of each connection may be adjusted so to improve the accuracy of the network 700 when classifying an input.

Accordingly, the layers 702, 704, 706 may be provided a corresponding input X and a weight matrix W. According to various aspects, the input X and a weight matrix W may each include a random variable that is independent from the other (e.g., each element of X and each element of W may be random variables). Because each of X and W is a random variable, various statistics may be computed. For example, such statistics may include the mean or expectation [symbol] [W] of the weight matrix W and the variance Var(W) of the weight matrix W. Similarly, such statistics may include the mean or expectation [symbol] [X] of the input X and the variance Var(X) of the input X. At the at least one hidden layer 704, for example, the preceding statistics may be computed using one or both of the normal probability distribution function, given by ϕ(⋅), and/or the normal cumulative distribution function, given by Φ(⋅).

In the neural network 700, a layer operation \textcircled{*} may be implemented, and the layer operation \textcircled{*} may describe how a given layer of the neural network operates and/or is connected—e.g., the layer operation \textcircled{*} may be a fully connected layer, a convolutional layer, a matrix multiplication layer, or another layer operation.

With X and W being independent random variables, the mean μ at an activation layer a (e.g., the at least one hidden layer 704, the output layer 706, etc.) may be μₐ= [symbol] [X] \textcircled{*} [symbol] [W]. The variance σ² at the activation layer a may be σₐ²=Var(X)\textcircled{*} Var(W)+Var(X) \textcircled{*} [symbol] [W]²+ [symbol] [X]² \textcircled{*} Var(W). Alternatively, the variance σ² at the activation layer a may be σₐ²=Var(X) \textcircled{*} ( [symbol] [W]²+Var(W))+ [symbol] [X]² \textcircled{*} Var(W). The activation distribution of the layer a may be a ˜ [symbol] (μₐ, σₐ²). Accordingly, the expectation of the activation layer [symbol] [a] and the variance of the activation layer Var(a) are computed.

In one aspect, the activation layer a is at the output layer 706 and, therefore, [symbol] [a] of the output layer 706 and Var(a) of the output layer 706 may computed. The original input provided to the input layer 702 may be classified based on [symbol] [a] of the output layer 706 and the variance Var(a) of the output layer 706. For example, the [symbol] [a] of the output layer 706 and the variance Var(a) of the output layer 706 may be used to select a point on each distribution at the output of each of the neurons 730, 732, 734, and the point may be used to classify the original input provided to the input layer 702.

However, when the activation layer a is at another layer (e.g., the at least one hidden layer 704), a ReLU function may be applied for variance propagation. Variance propagation with the ReLU function may be a function of two variables α and γ, where α=μₐ/σₐ and γ=ϕ(α)/Φ(α). The post ReLU mean for the activation layer may therefore be [symbol] [z]=Φ(α)μₐ+σₐΦ(α). Further, the post ReLU variance for the activation layer may therefore be Var(z)=Φ(α)((μₐ+σₐγ)²Φ(−α)+σₐ²(1−γ(γ+α))). The activation layer would then return [symbol] [z] and Var(z), which may cause variance propagation through that activation layer (e.g., the at least one hidden layer 704) of the neural network 700.

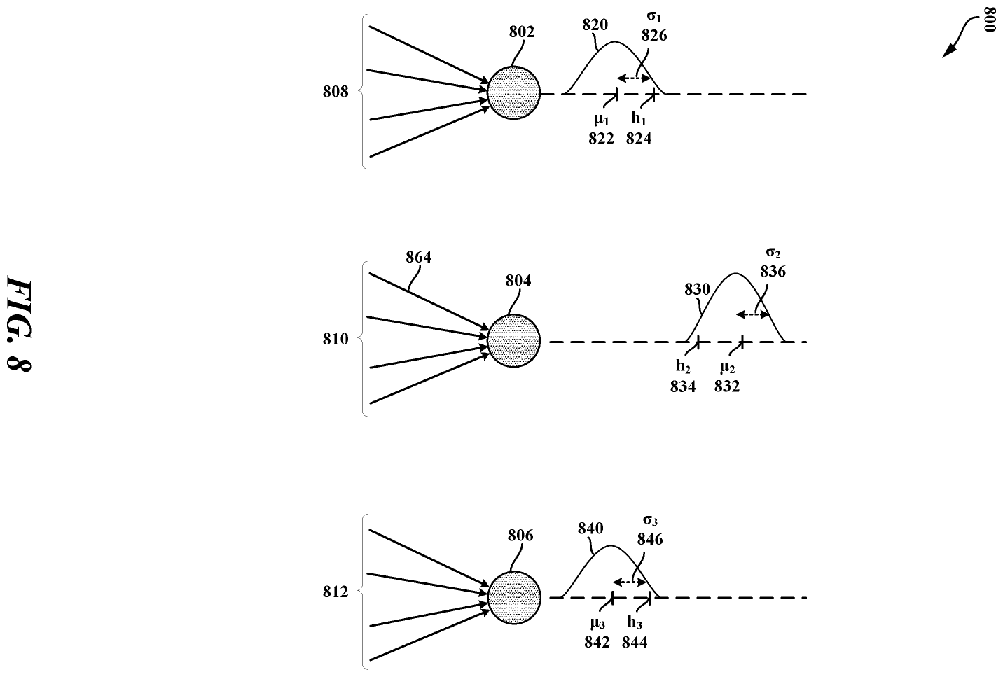

Turning to FIG. 8, an output layer 800 is illustrated in which variance is propagated through to the output layer 800. The output layer 800 includes a plurality of neurons 802, 804, 806. Illustratively, each of the neurons 802, 804, 806 may represent a classification. In the context of FIG. 7, the output layer 800 may be an aspect of the output layer 706.

With conventional neural networks, an output may be passed through a softmax activation function in order to squash the activations so that a probability distribution over classifications may be represented. Maximizing the likelihood of data may correspond to minimizing a cross-entropy loss with such a softmax activation function. Absent variance propagation, each output neuron would have a single scalar value prior to the softmax activation function. Conventionally, the activations z would be propagated through the softmax activation function in order to classify an input.

In contrast to the single scalar values of conventional neural networks, each of the neurons 802, 804, 806 of the output layer 800 may receive respective inputs 808, 810, 812 in which variances are propagated, e.g., as described with respect to FIG. 7. Correspondingly, each of the neurons 802, 804, 806 of the output layer 800 may have a distribution 820, 830, 840 (e.g., Gaussian distribution) prior to the softmax activation function, and each distribution may include a mean μ and a variance σ².

Illustratively, the second neuron 804 may correspond to the correct classification (e.g., true label) of an input. Accordingly, the second distribution 830 should assign a probability mass to values that are appreciably larger than the first and third distributions 820, 840, respectively corresponding to the first and third neurons 802, 806. In order to cause the mean μ₂ 832 of the activation of the second neuron 804, corresponding to the correct classification, to be relatively higher, while also causing the means μ₁ 822, μ₃ 842 of the activations of the first and third neurons 802, 806 to be relatively lower, a regularization term may be introduced, as shown in Equation 6.

$${h}_{i} = \{ \begin{matrix}{μ}_{i} - {δσ}_{i} , & if {y}_{i} = 1 \\ {μ}_{i} + {δσ}_{i} , & if {y}_{i} = 0\end{matrix} \qquad ( Equation 6 )$$

In Equation 6, y may be the vector of the expected classification (e.g., indicating the correct classification or true label of a data point x). Further, h may be a vector having an element that resembles a lower bound or quantile estimated for the correct classification and also having elements that resemble upper bounds or quantiles estimated for the incorrect classifications. Accordingly, an element hᵢ for a neuron may be different according whether the classification is correct or incorrect. In effect, the network 700 may be modified such that the network 700 tends toward a “pessimistic” position (e.g., because the activation of the neuron corresponding to the correct classification is reduced), but the network 700 still attempts to correctly predict classifications.

According to an example, for the second neuron 804, corresponding to the correct classification (e.g., y₂=1), the second standard deviation σ² 836 is multiplied by a scalar δ and the product is subtracted from the second mean μ₂ 832, resulting in a prediction of the second neuron 804 that may be h₂ 834. However, for the first neuron 802, corresponding to an incorrect classification (e.g., y₁=0), the first standard deviation σ₁ 826 is multiplied by the scalar δ and the product is added to the first mean μ₁ 822, resulting in a prediction of the first neuron 802 that may be h₁ 824. Similarly, for the third neuron 806, also corresponding to an incorrect classification (e.g., y₃=0), the third standard deviation σ³ 846 is multiplied by the scalar δ and the product is added to the third mean ν₁ 842, resulting in a prediction of the third neuron 806 that may be h₃ 844. In applying Equation 6 at the output layer 800 during training of the network 700, an acceptable quantization robustness may be achieved by through regularization.

During a training phase of the network 700, the weights of the inputs to one or more layers may be adjusted in order to train the network 700 to predict the correct classification. In particular, the weights of the inputs 808, 810, 812 may be adjusted based on the vector h. Accordingly, during operation of the network 700, quantization may be relatively more robust in response to the regularization through h.

Conventionally, the network 700 may be trained on a loss function L that is a function of an input x and the classification y: L(x,y). The weights of the inputs (e.g., the inputs 808, 810, 812) may be adjusted through the loss function L. In particular, a gradient of the loss function given a data point L(x,y) may be calculated, and the weights of the inputs (e.g., the inputs 808, 810, 812) may be adjusted in order to minimize the loss function L based on the gradient descent. For example, for a weight w₂ 864 at the output layer, a gradient descent may be applied to the loss function L to find a local minimum. In some aspects, the application of the gradient descent to the loss function L may be based on a weight of a previous layer (e.g., the weight of the input to at least one hidden layer below the output layer 800).

In some aspects, the loss function L(x,y) may include a cross-entropy (XE) function, and the cross-entropy function may be minimized. In some other aspects, the loss function L(x,y) may be a sum of two functions. As shown in Equation 7, the loss function L(x,y) may be a sum of a negative log likelihood (NLL) function and the cross-entropy (XE) function.

L(x,y)=NLL(x,y)+αXE(softmax(h),y) (Equation 7)

According to Equation 7, the loss function L(x,y) may be a sum of (1) the negative log likelihood function of an input x and the expected classification y, and (2) the cross-entropy function of the softmax activation function of h and the expected classification y. In some aspects, the negative log likelihood and/or the cross-entropy function may be minimized. A scalar α may be applied to the cross-entropy function, and the scalar α may be greater than 0. The scalar α may determine how strongly the normal loss of the network 700 is considered (i.e., the negative log likelihood) with respect to the regularization loss (i.e., the cross-entropy function). If the network 700 is able to place the cross-entropy (or regularization) function close to 0, then the network 700 may be trained to correctly classify an input when quantization is actually performed.

In effect, the loss function L(x,y) may include evaluation of the neural network 700 without any variance propagation, which is the negative log likelihood function of an input x and the expected classification y. Additionally, the loss function L(x,y) may include the cross-entropy function. The cross-entropy function may be computed on a prediction of the network 700 as defined by h and the expected classification y for the particular data point (x,y), which includes variance propagation through the network 700.

From the loss function L(x,y) shown in Equation 7, gradients may be computed and applied in order to minimize the loss function L(x,y). During training, this minimization of the loss function L(x,y) may be iteratively performed over a data set including a plurality of data points (e.g., similar to (x,y)) until the weights of the network 700 (e.g., the weights on inputs 808, 810, 812) cause the network 700 to satisfactorily perform for low-bit quantization.

Accordingly, during operation (e.g., production environment), an operational input may be provided to the network and the operational input may be classified by processing the operational input through the layers (e.g., the layers 702, 704, 706/800) using the weights that were adjusted based on the loss function L.

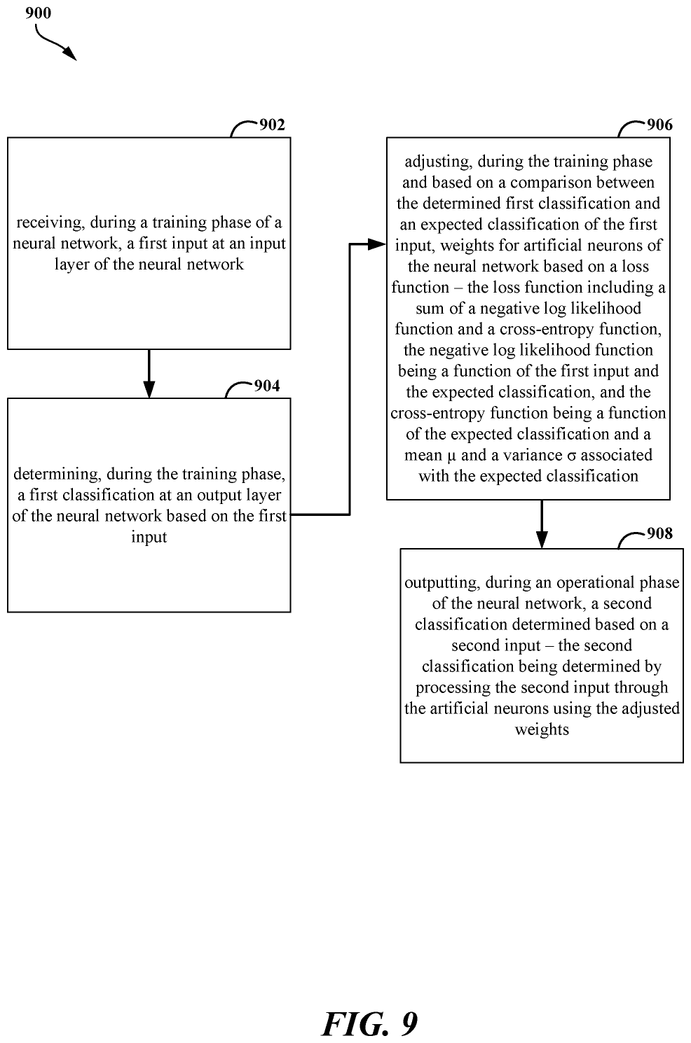

FIG. 9 illustrates a method 900 for variance propagation for quantization robustness. At operation 902, a neural network may receive, during a training phase of the neural network, a first input at an input layer of the neural network. Referring to FIG. 7, the input layer 702 of the network 700 may receive a first input, which may include x.

At operation 904, the neural network may determine, during the training phase, a first classification at an output layer of the neural network based on the first input. For example, the neural network may provide inputs to a set of layers of the neural network (e.g., including hidden layers), and a set of neurons of each of the set of layers. Each of the neurons may perform a respective calculation (e.g., using a function, such as a sigmoid function or other activation function) based on a respective input and further based on a respective weight and/or bias associated with each of the neurons. A subset of the set of neurons of each of the set of layers may be activated based on the respective calculation performed by each of the subset of the set of neurons. Referring to FIG. 7, the output layer 706 of the network 700 may determine a first classification that corresponds to the first input. Referring to FIG. 8, the output layer 800 may determine a first classification that corresponds to a first input, such as when the second neuron 804 is activated.

At operation 906, the neural network may adjust, during the training phase and based on a comparison between the determined first classification and an expected classification of the first input, weights for artificial neurons of the neural network based on a loss function. For example, the neural network may change at least one weight that is associated with at least one neuron of at least one layer of the neural network, and the neural network may store the at least one weight in memory. The neural network may associate the at least one weight with the at least one neuron and, accordingly, the at least one neuron may use the at least one weight when the at least one neuron performs a calculation (e.g., a function, such as a sigmoid function or other activation function) based on an input.

In aspects, the loss function may be a sum of a negative log likelihood function and a cross-entropy function. The negative log likelihood function may be a function of the first input and the expected classification, and the cross-entropy function may be a function of a mean μ and a variance σ² associated with the expected classification. In some aspects, the cross-entropy function further may be a function of the expected classification. In some aspects, a scalar α is applied to the cross-entropy function, the scalar α being greater than 0. In some aspects, the cross-entropy function is a function of a softmax operation that is based on the mean μ and the variance σ². In some aspects, the cross-entropy function is a function of a vector h, a respective element hᵢ being equal to μᵢ−δσ²ᵢ when the expected classification for an i^{th} output layer neuron is equal to 1, and the respective element hᵢ being equal to μᵢ+δσ²ᵢ when the expected classification for the i^{th} output layer neuron is equal to 0, wherein μᵢ is the mean of the expectation for the i^{th} output layer neuron, σ²ᵢ is the variance of the expectation for the i^{th} output layer neuron, and δ is a scalar greater than 0.

Referring to FIG. 7, the neural network 700 may adjust weights for the neurons of the layers 702, 704, 706. Referring to FIG. 8, the output layer 800 may have the weights for the inputs 808, 810, 812 adjusted based on comparison of the activation of the second neuron 804 and the expected classification y.

At operation 908, the neural network may output a second classification determined based on a second input, the second classification being determined by processing the second input through the artificial neurons using the adjusted weights. The neural network may output the second classification during an operational phase of the neural network. The second classification may be stored in memory accessible by the neural network. Referring to FIG. 7, the network 700 may output, based on a second input to the input layer 702, a second classification corresponding to activation of one of the neurons 730, 732, 734 of the output layer 706. Referring to FIG. 8, the output layer 800 may output a second classification corresponding to activation of one of the neurons 802, 804, 806 based on the inputs 808, 810, 812.

In some aspects, the method 900 may be performed by the SOC 100 (FIG. 1) or the system 200 (FIG. 2). That is, each of the elements of the method 900 may, for example, but without limitation, be performed by the SOC 100 or the system 200 or one or more processors (e.g., CPU 102 and local processing unit 202) and/or other components included therein. In some other aspects, the method 900 may be performed by the software architecture 400 (FIG. 4). That is, each of the elements of the method 900 may, for example, but without limitation, be performed by the SOC 420 and/or other components included therein.

In one configuration, an apparatus configured for operating a neural network may perform various operations described herein, for example, with respect to FIGS. 5-9. For example, the apparatus for operating the neural network may be configured to receive, during a training phase of the neural network, a first input at an input layer of the neural network. The apparatus for operating the neural network may be configured to determine, during a training phase, a first classification at an output layer of the neural network based on the first input. The apparatus for operating the neural network may be configured to adjust, during the training phase and based on a comparison between the determined first classification and an expected classification of the first input, weights for artificial neurons of the neural network based on a loss function—the loss function including a sum of a negative log likelihood function and a cross-entropy function, the negative log likelihood function being a function of the first input and the expected classification, and the cross-entropy function being a function of the expected classification and a mean μ and a variance σ² associated with the expected classification. The apparatus for operating the neural network may be configured to output a second classification determined based on a second input—the second classification being determined by processing the second input through the artificial neurons using the adjusted weights.

The apparatus for operating the neural network may include means for receiving, during a training phase of the neural network, a first input at an input layer of the neural network. The apparatus for operating the neural network may include means for determining, during a training phase, a first classification at an output layer of the neural network based on the first input. The apparatus for operating the neural network may include means for adjusting, during the training phase and based on a comparison between the determined first classification and an expected classification of the first input, weights for artificial neurons of the neural network based on a loss function—the loss function including a sum of a negative log likelihood function and a cross-entropy function, the negative log likelihood function being a function of the first input and the expected classification, and the cross-entropy function being a function of the expected classification and a mean μ and a variance σ² associated with the expected classification. The apparatus for operating the neural network may include means for outputting a second classification determined based on a second input—the second classification being determined by processing the second input through the artificial neurons using the adjusted weights.

According to various configurations, the receiving means, the determining means, the adjusting means, and/or the outputting means may be the general-purpose computer 102, program memory associated with the general purpose computer 102, memory block 118, local processing units 202, and/or the routing connection processing units 216 configured to perform the operations described herein. Illustratively, each local processing unit 202 may be configured to adjust, during a training phase of a neural network and based on a comparison between the determined first classification and an expected classification of the first input, weights for artificial neurons of the neural network based on a loss function.

In other configurations, the receiving means, the determining means, the adjusting means, and/or the outputting means may be the SOC 420 and/or another component of the software architecture 400. In still further configurations, the receiving means, the determining means, the adjusting means, and/or the outputting means may be any component and/or apparatus configured to perform the operations described by the aforementioned means.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, components and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software component executed by a processor, or in a combination of the two. A software component may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software component may include a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein include one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may include a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may include packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may include one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may include a number of software components. The software components include instructions that, when executed by the processor, cause the processing system to perform various functions. The software components may include a transmission component and a receiving component. Each software component may reside in a single storage device or be distributed across multiple storage devices. By way of example, a software component may be loaded into RAM from a hard drive when a triggering event occurs. During execution of the software component, the processor may load some of the instructions into cache to increase access speed. One or more cache lines may then be loaded into a general register file for execution by the processor. When referring to the functionality of a software component below, it will be understood that such functionality is implemented by the processor when executing instructions from that software component. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may include non-transitory computer-readable media (e.g., tangible media). In addition, for other aspects computer-readable media may include transitory computer-readable media (e.g., a signal). Combinations of the above should also be included within the scope of computer-readable media.

Thus, certain aspects may include a computer program product for performing the operations presented herein. For example, such a computer program product may include a computer-readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of operation of a neural network, the method comprising:
receiving, during a training phase of the neural network, a first input at an input layer of the neural network;
determining, during the training phase, a first classification at an output layer of the neural network based on the first input; and
adjusting, during the training phase and based on a comparison between the determined first classification and an expected classification of the first input, weights for artificial neurons of the neural network based on a loss function, the loss function being based on a cross-entropy function, and the cross-entropy function being a function of a mean μ and a variance σ² associated with the expected classification.

2. The method of claim 1, wherein the loss function comprises a sum of a negative log likelihood function and the cross-entropy function, and the negative log likelihood function is a function of the first input and the expected classification.

3. The method of claim 1, further comprising:
outputting a second classification determined based on a second input, the second classification being determined by processing the second input through the artificial neurons using the adjusted weights.

4. The method of claim 1, wherein a scalar α is applied to the cross-entropy function, the scalar α being greater than 0.

5. The method of claim 1, wherein the cross-entropy function is a function of a softmax operation that is based on the mean μ and the variance σ².

6. The method of claim 1, wherein the cross-entropy function is a function of a vector h, a respective element hᵢ being equal to μᵢ−δσ²ᵢ when the expected classification for an i^{th} output layer neuron is equal to 1, and the respective element hᵢ being equal to μᵢ+δσ²ᵢ when the expected classification for the i^{th} output layer neuron is equal to 0, wherein μᵢ is the mean of the expectation for the i^{th} output layer neuron, σ²ᵢ is the variance of the expectation for the i^{th} output layer neuron, and δ is a scalar greater than 0.

7. A neural network comprising:
means for receiving, during a training phase of the neural network, a first input at an input layer of the neural network;
means for determining, during the training phase, a first classification at an output layer of the neural network based on the first input; and
means for adjusting, during the training phase and based on a comparison between the determined first classification and an expected classification of the first input, weights for artificial neurons of the neural network based on a loss function, the loss function being based on a cross-entropy function, and the cross-entropy function being a function of a mean μ and a variance σ² associated with the expected classification.

8. The neural network of claim 7, wherein the loss function comprises a sum of a negative log likelihood function and the cross-entropy function, and the negative log likelihood function is a function of the first input and the expected classification.

9. The neural network of claim 7, further comprising:
means for outputting a second classification determined based on a second input, the second classification being determined by processing the second input through the artificial neurons using the adjusted weights.

10. The neural network of claim 7, wherein a scalar α is applied to the cross-entropy function, the scalar α being greater than 0.

11. The neural network of claim 7, wherein the cross-entropy function is a function of a softmax operation that is based on the mean μ and the variance σ².

12. The neural network of claim 7, wherein the cross-entropy function is a function of a vector h, a respective element hᵢ being equal to μᵢ−δσ²ᵢ when the expected classification for an i^{th} output layer neuron is equal to 1, and the respective element hᵢ being equal to μᵢ+δσ²ᵢ when the expected classification for the i^{th} output layer neuron is equal to 0, wherein μᵢ is the mean of the expectation for the i^{th} output layer neuron, σ²ᵢ is the variance of the expectation for the i^{th} output layer neuron, and δ is a scalar greater than 0.

13. A neural network comprising:
a memory; and
at least one processor coupled to the memory and configured to:
receive, during a training phase of the neural network, a first input at an input layer of the neural network;
determine, during the training phase, a first classification at an output layer of the neural network based on the first input; and
adjust, during the training phase and based on a comparison between the determined first classification and an expected classification of the first input, weights for artificial neurons of the neural network based on a loss function, the loss function comprising a sum of a negative log likelihood function and a cross-entropy function, the negative log likelihood function being a function of the first input and the expected classification, and the cross-entropy function being a function of a mean μ and a variance σ² associated with the expected classification.

14. The neural network of claim 13, wherein the loss function comprises a sum of a negative log likelihood function and the cross-entropy function, and the negative log likelihood function is a function of the first input and the expected classification.

15. The neural network of claim 13, wherein the at least one processor is further configured to:
output a second classification determined based on a second input, the second classification being determined by processing the second input through the artificial neurons using the adjusted weights.

16. The neural network of claim 13, wherein a scalar α is applied to the cross-entropy function, the scalar α being greater than 0.

17. The neural network of claim 13, wherein the cross-entropy function is a function of a softmax operation that is based on the mean μ and the variance σ².

18. The neural network of claim 11, wherein the cross-entropy function is a function of a vector h, a respective element hᵢ being equal to μᵢ−δσ²ᵢ when the expected classification for an i^{th} output layer neuron is equal to 1, and the respective element hᵢ being equal to μᵢ+δσ²ᵢ when the expected classification for the i^{th} output layer neuron is equal to 0, wherein μᵢ is the mean of the expectation for the i^{th} output layer neuron, σ²ᵢ is the variance of the expectation for the i^{th} output layer neuron, and δ is a scalar greater than 0.

19. A computer-readable medium storing computer-executable code for operation of a neural network, comprising code to:
receive, during a training phase of the neural network, a first input at an input layer of the neural network;
determine, during the training phase, a first classification at an output layer of the neural network based on the first input; and
adjust, during the training phase and based on a comparison between the determined first classification and an expected classification of the first input, weights for artificial neurons of the neural network based on a loss function, the loss function being based on a cross-entropy function, and the cross-entropy function being a function of a mean μ and a variance σ² associated with the expected classification.

20. The computer-readable medium of claim 19, wherein the loss function comprises a sum of a negative log likelihood function and the cross-entropy function, and the negative log likelihood function is a function of the first input and the expected classification.

21. The computer-readable medium of claim 19, further comprising code to:
output a second classification determined based on a second input, the second classification being determined by processing the second input through the artificial neurons using the adjusted weights.

22. The computer-readable medium of claim 19, wherein a scalar α is applied to the cross-entropy function, the scalar α being greater than 0.

23. The computer-readable medium of claim 19, wherein the cross-entropy function is a function of a softmax operation that is based on the mean μ and the variance σ².

24. The computer-readable medium of claim 19, wherein the cross-entropy function is a function of a vector h, a respective element hᵢ being equal to μᵢ−δσ² ᵢ when the expected classification for an i^{th} output layer neuron is equal to 1, and the respective element hᵢ being equal to μᵢ+δσ²ᵢ when the expected classification for the i^{th} output layer neuron is equal to 0, wherein μᵢ is the mean of the expectation for the i^{th} output layer neuron, σ²ᵢ is the variance of the expectation for the i^{th} output layer neuron, and δ is a scalar greater than 0.
